(19) United States
(12) Patent Application Publication
(10) Pub. No.: US 2008/0230307 A1
(43) Pub. Date: Sep. 25, 2008

(54) MUFFLE DUCT

(75) Inventors: Taketoshi MATSUMOTO, Hamamatsu-shi (JP); Takahiro AMANO, Hamamatsu-shi (JP); Shuhei SEI, Hamamatsu-shi (JP)

Correspondence Address: Young & Thompson, 209 Madison Street, Suite 500, Alexandria, VA, 22314, US

(73) Assignee: TOYO ROKI SEIZO KABUSHIKI KAISHA, Hamamatsu-shi (JP)

(21) Appl. No.: 12/052,973

(22) Filed: Mar. 21, 2008

(30) Foreign Application Priority Data
Mar. 22, 2007 (JP) 2007-074536

(51) Int. Cl. F02M 35/12

(52) U.S. Cl. 181/229

(57) ABSTRACT

A pipe is incorporated in an intake system and has a first hole for a noise in the intake system to be released therethrough. A cover covers the pipe for attenuating the noise and has a second hole coinciding with the first hole circumferentially of the pipe.

### CROSS-REFERENCE TO RELATED APPLICATIONS

This application is based upon and claims the benefit of priority from Japanese Patent Application No. 2007-74536 filed on Mar. 22, 2007; the entire contents of which are incorporated herein by reference.

### BACKGROUND OF THE INVENTION

The invention relates to a muffle duct applicable for an intake system of, for example, an internal combustion, an air conditioner or an air compressor.

A general intake duct causes a noise when allowing air to be taken or be discharged therethrough.

A related intake duct includes a resonator for muffling the noise. The resonator is required to have 4 to 8 L (liter) for a low frequency and 0.2 to 0.5 L (liter) for a middle frequency (Refer to Patent Document 1).

Another intake duct includes a nonwoven fabric adhered to the internal. This nonwoven fabric produces an effect of preventing resonance of a noise in the duct (Refer to Patent Document 2).

Another intake duct includes a sound absorption material wound around the outer circumference (Refer to Patent Document 3).

Another intake duct includes an expansion chamber. This expansion chamber produces an effect of muffling a noise of a high frequency range (Refer to Patent Document 4).

Patent Document 1: Japanese Patent Application Laid-open No. Hei 6-159174

Patent Document 2: Japanese Patent Application Laid-open No. 2003-343373

Patent Document 3: Utility Model Application Laid-open No. Hei 5-38352

Patent Document 4: Japanese Patent Application Laid-open No. Hei 9-144986

Any of the intake ducts, however, produces the effect of muffling a noise of a predetermined frequency range. An intake duct has not been developed, producing the effect of muffling noises of all frequency ranges.

The invention is directed to a muffle duct to muffle noises of high, middle and high frequency ranges.

### SUMMARY OF THE INVENTION

The first aspect of the invention provides the following muffle duct. The muffle duct includes a pipe incorporated in an intake system and having a first hole for a noise in the intake system to be released therethrough. The muffle duct includes a cover covering the pipe for attenuating the noise and having a second hole coinciding with the first hole circumferentially of the pipe.

The cover may include a guide for guiding a noise from the second hole.

The second hole may have a slit.

The first hole may have a slit.

### BRIEF DESCRIPTION OF THE ACCOMPANYING DRAWINGS

FIG. 1 is a schematic view of an intake system in which a muffle duct according to a first embodiment of the invention is applied;

FIG. 2A is a perspective view of the muffle duct illustrated in FIG. 1;

FIG. 2B is a cross sectional view of the muffle duct;

FIG. 2C is an enlarged view of a guide in a modified muffle duct;

FIG. 3A is an exploded perspective view of the muffle duct;

FIG. 3B is an enlarged perspective view of the outer pipe;

FIG. 3C is a cross sectional view of the muffle duct;

FIG. 4A is a schematic plan view of the muffle duct;

FIG. 4B is a schematic plan view of the muffle duct having a modified inner pipe;

FIG. 4C is a schematic plan view of the muffle duct having a modified inner pipe;

FIG. 5A is a graph showing a muffle effect in comparison between an example and a comparative example 1;

FIG. 5B is a graph showing a muffle effect in comparison between an example and a comparative example 2;

FIG. 6A is a plan view of a muffle duct according to a second embodiment;

FIG. 6B is a sectional view of the muffle duct;

FIG. 6C is a sectional view of the muffle duct according to a modified embodiment;

FIG. 7A is an exploded perspective view of a muffle duct illustrated in FIG. 6;

FIG. 7B is a perspective view of an inner pipe; and

FIG. 7C is a cross sectional view of the muffle duct.

### DETAILED DESCRIPTION OF THE EMBODIMENTS

Embodiments of the invention will be described below with reference to the accompanying drawings.

### First Embodiment

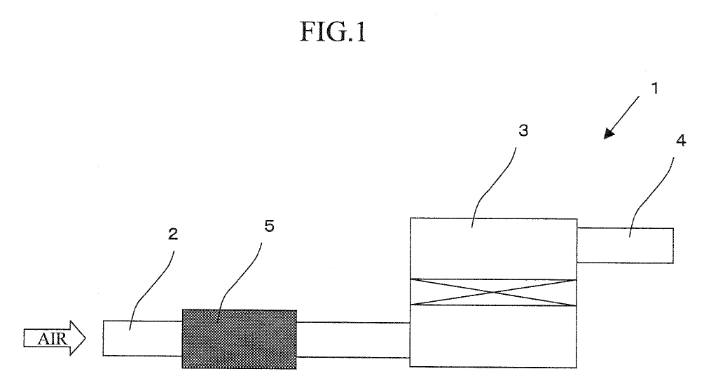

With reference to FIG. 1, an intake system 1 includes an intake duct 2 for air intake, an air cleaner 3 connected to the intake duct 2, an air flow tube 4 connected to the air cleaner 3 and placed on the engine side, and a muffle duct 5 incorporated in the intake duct 2.

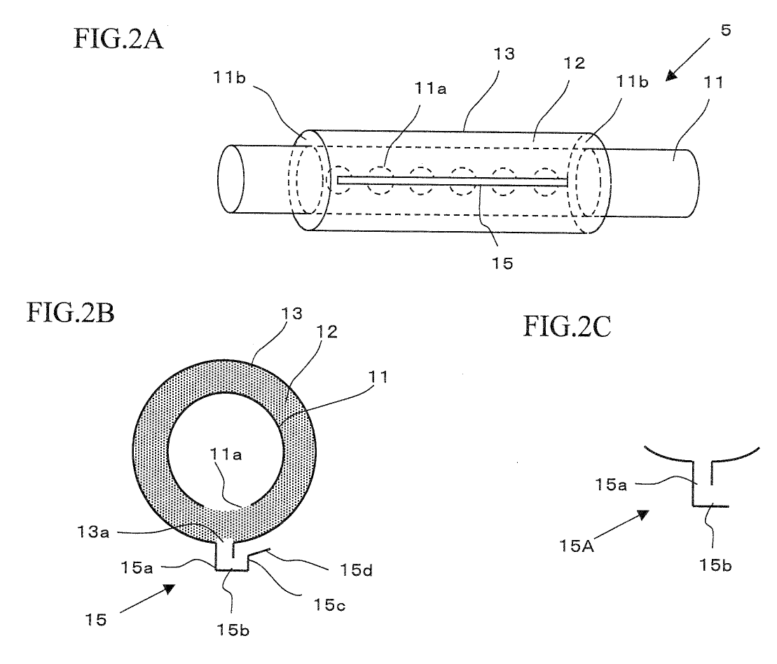

With reference to FIGS. 2A and 2B, the muffle duct 5 includes an inner pipe 11 connected to the intake duct 2, a sound absorption material 12 enclosing the inner pipe 11, and an outer pipe 13 as a cover enclosing the sound absorption material 12.

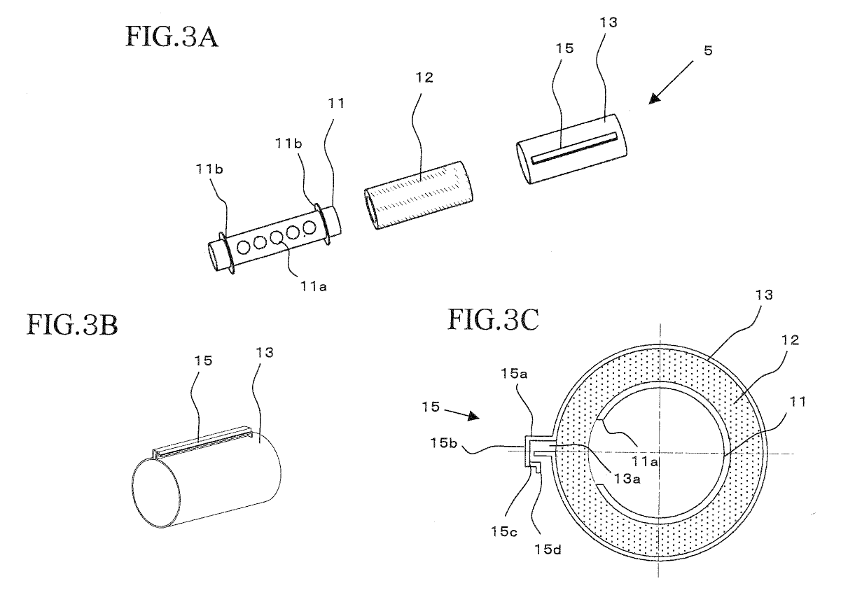

With reference to FIGS. 3A, the cylindrical inner pipe 11 has a pair of flanges 11b at both the ends in the direction of the cylindrical axis (referred to as an axial direction). The inner pipe 11 has circular holes 11a each as a first hole arranged between the flanges 11b in the axial direction. These circular holes 11a allow a noise in the intake duct to be released therethroguh, preventing resonance in the intake duct 2.

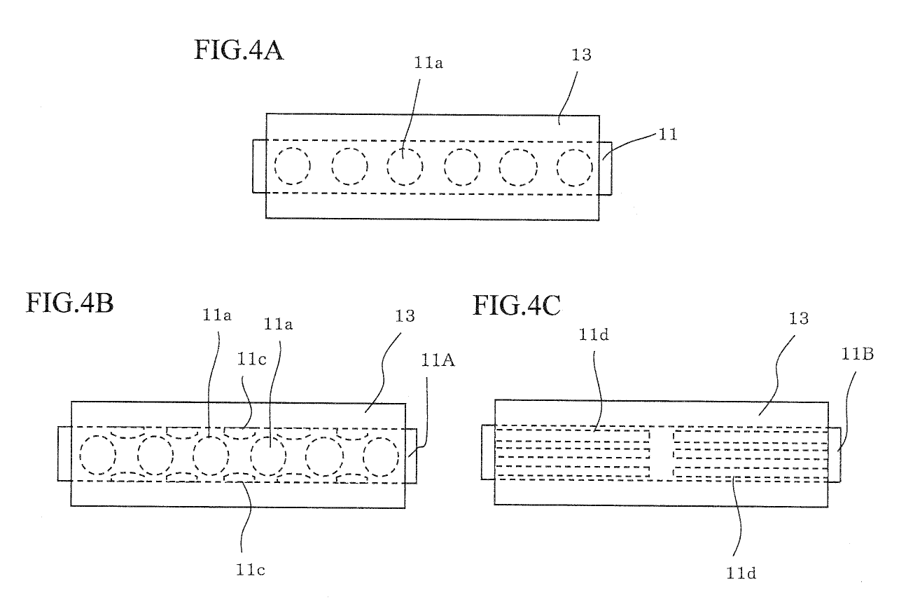

With reference to FIGS. 4B and 4C, inner pipes 11A and 11B according to modified embodiments are described. The inner pipe 11A has circular holes 11c between circular holes 11a positioned at the four rectangular vertexes (Refer to FIG. 4B).

The inner pipe 11B has slits 11d arranged in two rows in the axial direction (Refer to FIG. 4C). The slits 11d are arranged at predetermined intervals in the circumferential direction.

With reference to FIGS. 2A and 2B, the cylindrical sound absorption material 12 is held between the flanges 11b, covering the circular holes 11a. The sound absorption material 12 employs, for example, a polyurethane foam having continuous foams, a polyethylene foam, a melanine resin foam, a nonwoven fabric, or a fiber element.

The cylindrical outer pipe 13 is placed between the flanges 11b of the inner pipe 11, covering the sound absorption material 12. The outer pipe 13 has a slit 13a as a second hole extending in the axial direction (Refer to FIG. 2B). The slit 13a is positioned on the straight line with the circular holes 11a. That is, the slit 13a coincides in circumferential position (angular position) with the circular positions 11a. Therefore, the slit 13a coincides with the circular holes 11a, facing the holes 11a. The outer pipe may be a thin film.

With reference to FIG. 2B, the outer pipe 13 has a guide 15 extending outside from the slit 13a. The guide 15 includes a guide pipe 15a extending radially outward from the slit 13a. The guide 15 includes a first guide plate 15b extending transversely from the guide pipe 15a. The guide 15 includes a second guide plate 15c extending from the first guide plate 15b toward the outer pipe 13. The guide 15 includes a third guide plate 15d obliquely extending from the second guide plate 15c.

With reference to FIG. 2C, the guide 15 may be replaced by a guide 15A of the guide pipe 15a and the first guide plate 15b.

Next, a method of operating the intake system 1 is described.

With reference to FIG. 1, for example, when an engine starts, the intake valve allows an air to be taken therethrough. The air flows into the intake duct 2 to pass through the air cleaner 3, being taken from the air flow tube 4 into the engine side. The air produces a pulsation in the intake valve, causing an intake noise. The intake noise transmits via the reverse path to the above path to radiate from the intake.

Then, with reference to FIG. 2, the inner pipe 11 allows the intake noise to be released from the elongated holes 11a into the outer pipe 13. The sound absorption material 12 absorbs an intake noise of a high frequency range of 1000 Hz or more from the released intake sound. The outer pipe 13 attenuates the noise of a high frequency range due to a chamber effect. The slit 13a of the outer pipe 13 allows an intake noise of a middle frequency range from 50 Hz to 1000 Hz to be released outside, preventing resonance in the chamber duct 5, thus reducing the intake noise of the middle frequency range. Herein, the slit 13a coincides in circumferential position (angular position) with the circular holes 11a. This structure allows an intake noise of a low frequency range of 150 Hz or less to be released from the slit 13a.

The released intake noise is guided by the guide pipe 15a outward of the outer pipe 13 to strike against the second guide plate 15b. The first guide plate 15b bends the travel direction of the intake noise at a right angle relative to the guide pipe 15a. The second guide plate 15c bends the travel direction of the intake noise at a right angle relative to the first guide plate 15b. The intake noise strikes against the outer pipe 13 to travel along the third guide plate 15d to radiate outside.

When water tends to enter the muffle duct 5, the guide pipe 15a encloses the inlet of the slit 13a and the first to third guide plates 15b, 15c and 15d provide complication to the path of entering of the water, thus preventing water from entering.

According to the above muffle duct 5, it efficiently attenuates intake noises of low, middle and high frequency from 20 Hz to 2000 Hz.

The guide 15 provides complication to the path to the slit 13a of the outer pipe 13, thus preventing water from entering.

The slit 13a provides directionality to the direction of radiating the intake noise.

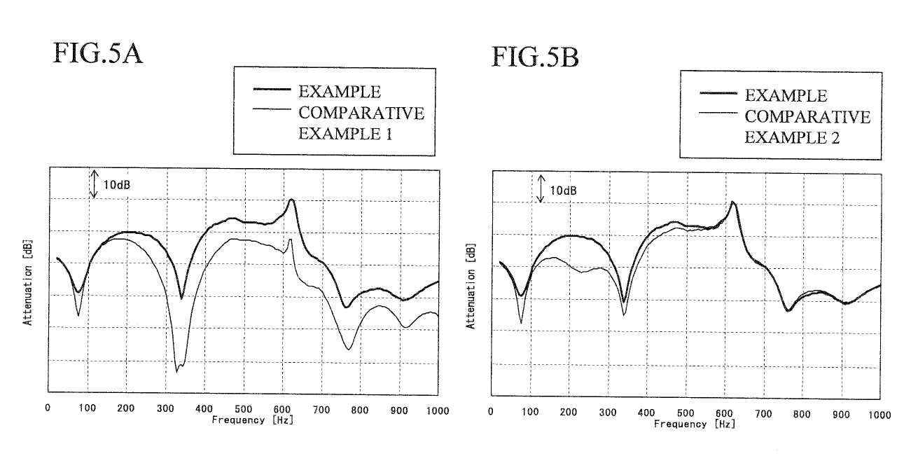

Next, with reference to FIG. 5, the experimental result of the muffle duct 1 is described.

The graph illustrated in FIG. 5A provides a result from the comparison between an example and a comparative example 1. The example includes the muffle duct 5 of the embodiment placed in the intake duct 2 as illustrated in FIG. 1. The comparative example 1 includes a duct without any muffles. The horizontal axis indicates frequency of intake noise. The vertical axis indicates attenuation of intake noise of a frequency.

The example shows a large attenuation of around 20 dB at the maximum for noises of substantially whole low and middle frequency ranges from 20 Hz to 1000 Hz, comparing to the comparative example 1.

The graph illustrated in FIG. 5B provides a result from the comparison between the example and a comparative example 2. The comparative example 2 includes a muffle duct similar to one of the embodiment, having a structure having an outer pipe without any holes. The example and the comparative example 2 show equal attenuations for intake noises of 600 Hz or more. For an intake noise of 600 Hz or less, the example shows an attenuation larger than that of the comparative example 2. Specifically, for an intake noise of approximately 80 Hz in a low frequency range of 100 Hz or less, the example shows an attenuation greater than that of the comparative example by around 10 dB.

According to the above description, it is shown that the example attenuates intake noises of low and middle frequency ranges from 20 Hz to 2000 Hz. The example shows a preferable attenuation for intake noise of a high frequency range.

### Second Embodiment

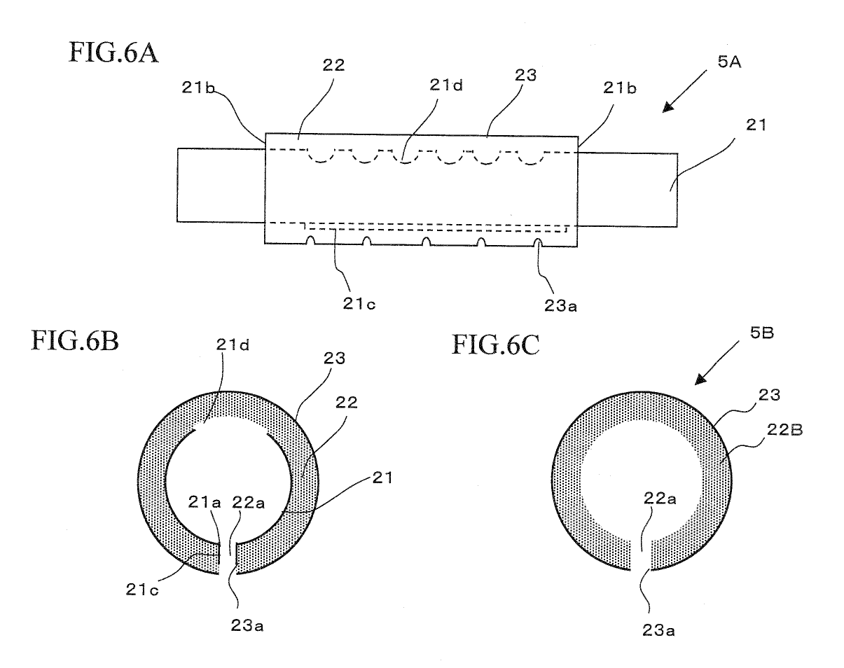

With reference to FIGS. 6A, 6B and 6C, the muffle duct 5A includes an inner pipe 21 as a pipe, a sound absorption material 22 placed on the inner pipe 21, and an outer pipe 23 as a cover on the circumference of the sound absorption material 22.

The inner pipe 21 includes a pair of flanges 21b at both the ends in the axial direction.

The inner pipe 21 has a slit 21a extending between the flanges 21b in the axial direction (Refer to FIG. 6B). The inner pipe 21 includes a guide 21c extending radially outward from the slit 21a.

The inner pipe 21 has circular holes 21d placed opposite to the slit 21a. The circular holes 21d are arranged in the axial direction.

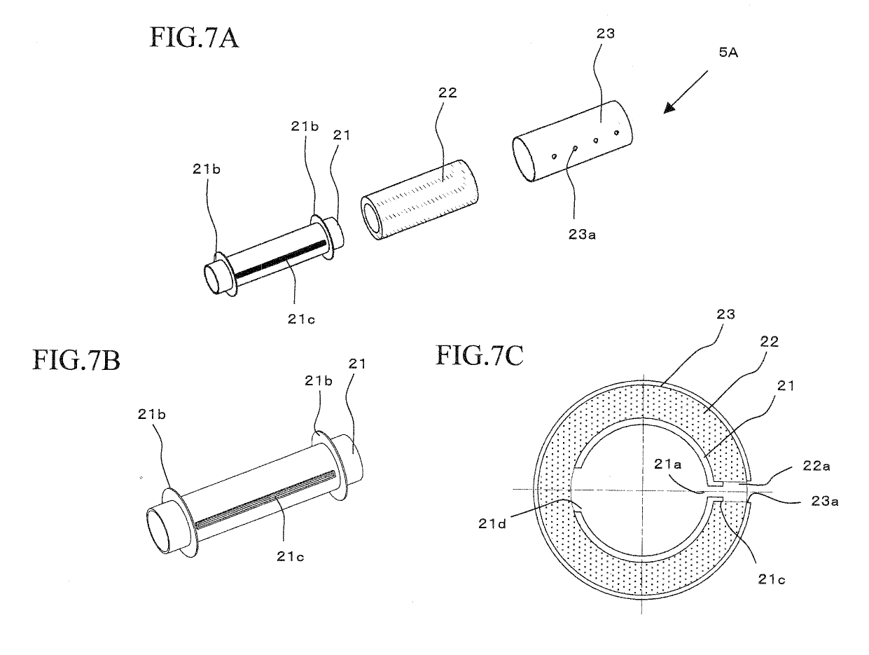

With reference to FIG. 7A, 7B and 7C, the sound absorption material 22 is held between the flanges 21b. The sound absorption material 22 has an elongated hole 22a coinciding with the slit 21a of the inner pipe 21. The elongated hole 22a has the guide 21c of the inner pipe 21 inserted therein.

The outer pipe 23 covers the circumferential surface of the sound absorption material 22. The outer pipe 23 has relief holes 23a arrayed in the axial direction. These relief holes 23a are positioned on the straight line with the slit 21a of the inner pipe 21 and the elongated holes 22a of the sound absorption material 22. Therefore, the relief holes 23a coincide with the slit 21a and the elongated holes 22a, facing them 21a and 22a.

The above-described muffle duct 5A muffles intake noises of low, middle and high frequencies, as well as the first embodiment.

The slit 21a provides directionality to the direction of radiating the intake noise.

The elongated hole 22a of the sound absorption material 22 allows dust to pass from outside through the slit 21a to come out of the inner pipe 21, thus preventing the sound absorption material 22 from being clogged.

With reference to FIG. 6C, the muffle duct 5A may be replaced by a muffle duct 5B according to a modified embodiment. The muffle duct 5B employs a molded sound absorption material 22B. Employment of the sound absorption material 22B allows for omission of the inner pipe, rendering the structure of the device simple.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

The muffle ducts 5 and 5A according to the first and second embodiments may be applied to not only the intake system but also an exhaust system.

The muffle duct 5 and 5A may be applied to not only an internal combustion but, for example, an air conditioner or an air compressor of a device causing noise. According to the aspect of the invention, an noise in the intake system travels through the first hole of the pipe to enter the cover. The cover attenuates noises of middle and high frequencies. The cover radiates a noise of a low frequency range from the second hole. Thus, the noise in the intake system attenuates in the low, middle and high frequency ranges.

The guide renders the path to the second hole complicated, allowing entering of water to be difficult.

The first and second holes are formed in a slit, providing directionality to the direction of radiating the intake noise.

What is claimed is:

1. A muffle duct comprising:
a pipe incorporated in an intake system and having a first hole for a noise in the intake system to be released therethrough; and
a cover covering the pipe for attenuating the noise and having a second hole coinciding with the first hole circumferentially of the pipe.

2. The muffle duct according to claim 1,
wherein the cover includes a guide for guiding a noise from the second hole.

3. The muffle duct according to claim 1,
wherein the second hole has a slit.

4. The muffle duct according to claim 1,
wherein the first hole has a slit.
